(19) United States
(12) Patent Application Publication
(10) Pub. No.: US 2019/0325496 A1
(43) Pub. Date: Oct. 24, 2019

(54) METHODS, SYSTEMS, APPARATUSES AND DEVICES FOR FACILITATING CUSTOMIZING A CARD

(71) Applicants: Sergei Schurkin, Dublin (IE); Stanislav Provorov, Dublin (IE)

(72) Inventors: Sergei Schurkin, Dublin (IE); Stanislav Provorov, Dublin (IE)

(21) Appl. No.: 16/459,270

(22) Filed: Jul. 1, 2019

Related U.S. Application Data
(63) Continuation-in-part of application No. PCT/IB2018/051377, filed on Mar. 5, 2018.
(60) Provisional application No. 62/441,858, filed on Jan. 3, 2017.

(51) Int. Cl. G06Q 30/06; H04L 29/06; G06Q 20/34; G06F 3/0482

(52) U.S. Cl. CPC G06Q 30/0621; H04L 63/08; H04L 67/10; G06Q 30/0631; G06F 3/0482; G06Q 20/3558

(57) ABSTRACT

A system for customizing a card may include a communication device configured for receiving a customization request for generating a customized card from a user device, transmitting an executable content to the user device, and receiving at least one manipulated digital content. The executable content, upon execution on a processor included in the user device, may be configured for receiving, using an input device, a selection of at least one digital content, retrieving, using a memory device, at least one digital content, receiving, using the input device, at least one digital content manipulation, generating, using the processor, the at least one manipulated digital content based on the at least one digital content and the at least one digital content manipulation, and transmitting, using a transceiver device, the at least one manipulated digital content. The system may include a storage device configured for storing the at least one manipulated digital content.

The current application claims a priority to a Patent Cooperation Treaty (PCT) application with a serial number PCT/IB2018/051377 filed on Mar. 5, 2018. The PCT application PCT/IB2018/051377 claims a priority to a U.S. provisional application Ser. No. 62/441,858 filed on Jan. 3, 2017

### TECHNICAL FIELD

Generally, the present disclosure relates to the field of card customization. More specifically, the present disclosure relates to methods, systems, apparatuses and devices for customizing a card.

### BACKGROUND

Typically, individuals own multiple cards such as debit cards, credit cards, gift cards, loyalty cards, cards issued by one or more of governments, retail networks, software vendors (e.g. Apple iTunes cards), and fast-food networks (e.g., Burger King, Starbucks). Generally, the cards are not customized as per user's requirements. However, the users may wish to customize various cards owned by them.

Therefore, some institutions (such as banks) allow users to customize the cards issued by the institution. However, the customization includes image manipulation performed on the server-side. Further, the users may customize the cards by selecting images from image sources. However, the image sources may be limited. For example, the users may not be allowed to upload their own images. Further, the users may be forced to select images only from preset image galleries. Moreover, the customization may include printing the cards within the respective institution only.

Therefore, there is a need for improved methods, systems, apparatuses and devices for customizing a card that may overcome one or more of the above-mentioned problems and/or limitations.

### BRIEF SUMMARY

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a computer implemented method for customizing a card, in accordance with some embodiments. Accordingly, the computer implemented method may include receiving, using a communication device, a customization request for generating a customized card from a user device. Further, the computer implemented method may include transmitting, using the communication device, an executable content to the user device based on the customization request. Further, the executable content, upon execution on a processor included in the user, may be configured for receiving, using an input device, a selection of at least one digital content. Further, the executable content may be configured for retrieving, using a memory device, the at least one digital content based on the selection. Further, the executable content may be configured for receiving, using the input device, at least one digital content manipulation. Further, the executable content may be configured for generating, using the processor, at least one manipulated digital content based on the at least one digital content and the at least one digital content manipulation. Further, the executable content may be configured for transmitting, using a transceiver device, the at least one manipulated digital content. Further, the computer implemented method may include receiving, using the communication device, the at least one manipulated digital content. Further, the computer implemented method may include storing, using a storage device, the at least one manipulated digital content.

Further disclosed herein is a system for customizing a card, in accordance with some embodiments. Accordingly, the system may include a communication device configured for receiving a customization request for generating a customized card from a user device. Further, the communication device may be configured for transmitting an executable content to the user device based on the customization request. Further, the executable content, upon execution on a processor included in the user device, may be configured for receiving, using an input device, a selection of at least one digital content. Further, the executable content may be configured for retrieving, using a memory device, at least one digital content based on the selection. Further, the executable content may be configured for receiving, using the input device, at least one digital content manipulation.

Further, the executable content may be configured for generating, using the processor, at least one manipulated digital content based on the at least one digital content and the at least one digital content manipulation. Further, the executable content may be configured for transmitting, using a transceiver device, the at least one manipulated digital content. Further, the communication device may be configured for receiving the at least one manipulated digital content. Further, the system may include a storage device configured for storing the at least one manipulated digital content.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF DRAWINGS

The accompanying drawings, which are incorporated in and constitute a part of this disclosure, illustrate various embodiments of the present disclosure. The drawings contain representations of various trademarks and copyrights owned by the Applicants.

In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of a platform consistent with various embodiments of the present disclosure.

FIG. 2 is a block diagram representation of a system for customizing a card, in accordance with some embodiments.

FIG. 3 is a flowchart of a computer implemented method for customizing a card, in accordance with some embodiments.

FIG. 4 is a flowchart of a computer implemented method to facilitate obtaining identifier for manipulated digital content, in accordance with some embodiments.

FIG. 5 is a flowchart of a computer implemented method for facilitating customized card printing, in accordance with some embodiments.

FIG. 6 is a flowchart of a computer implemented method to facilitate determining an accessibility of a digital content, in accordance with some embodiments.

FIG. 7 is a flowchart of a computer implemented method for customizing a card, in accordance with some embodiments.

FIG. 8 is a flowchart of a computer implemented method of customizing a card in accordance with some embodiments.

FIG. 9 is a block diagram corresponding to a set of system architecture flow processes in accordance with some embodiments.

FIG. 10 is a flowchart corresponding to a set of user flow processes, in accordance with some embodiments.

FIG. 11 is an exemplary representation of a user interface for allowing a user to upload an image, in accordance with an exemplary embodiment.

FIG. 12 is an exemplary representation of a user interface for allowing a user to upload an image, in accordance with an exemplary embodiment.

FIG. 13 is an exemplary representation of a user interface for allowing a user to upload an image, in accordance with an exemplary embodiment.

FIG. 14 is an exemplary representation of a user interface for allowing a user to apply image manipulation, in accordance with an exemplary embodiment.

FIG. 15 is an exemplary representation of a user interface for allowing a user to apply image manipulation, in accordance with an exemplary embodiment.

FIG. 16 is an exemplary representation of a user interface showing a confirmation message to a user, in accordance with an exemplary embodiment.

FIG. 17 illustrates an exemplary computing system that may be employed to implement processing functionality for various embodiments.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of customizing a card, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

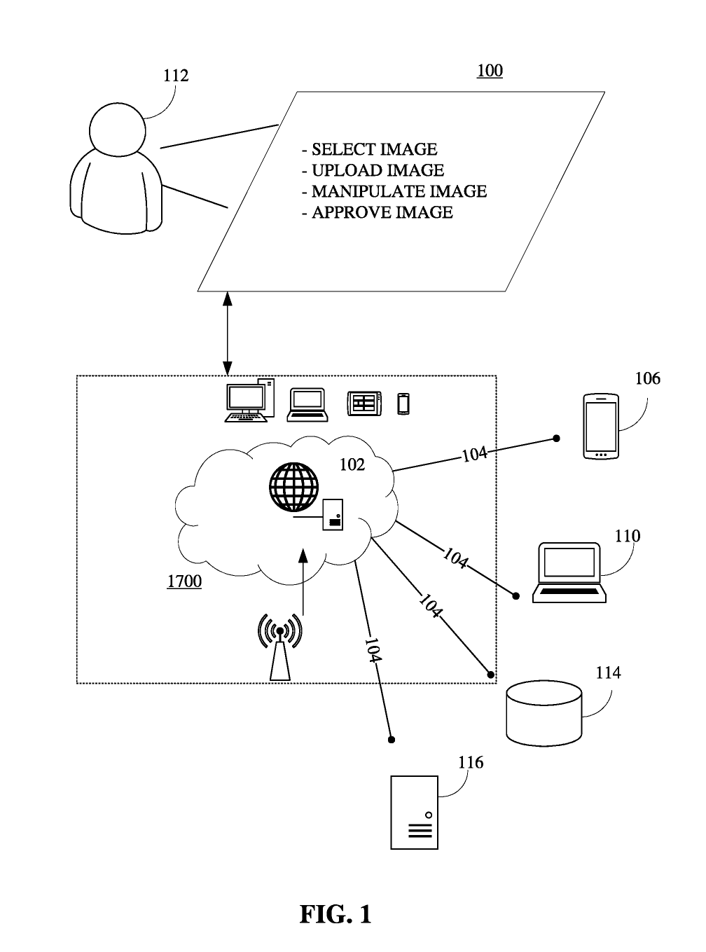

Referring now to figures, FIG. 1 is an illustration of a platform 100 consistent with various embodiments of the present disclosure. By way of non-limiting example, the online platform 100 for customizing a card may be hosted on a centralized server 102, such as, for example, a cloud computing service. The centralized server 102 may communicate with other network entities, such as, for example mobile devices 106 (such as a smartphone, a laptop, a tablet computer etc.), other electronic devices 110 (such as desktop computers, etc.), databases 114 (such as image databases), a personalization server 116 via a communication network 104 such as, but not limited to, the Internet. Further, users of the platform may include one or more relevant parties such as users, card company officials, and system administrators. Accordingly, electronic devices operated by the one or more relevant parties may be in communication with the platform 100.

A user 112, such as the one or more relevant parties, may access platform 100 through a software application. The software application may be embodied as, for example, but not be limited to, a website, a web application, a desktop application, and a mobile application compatible with a computing device 1700.

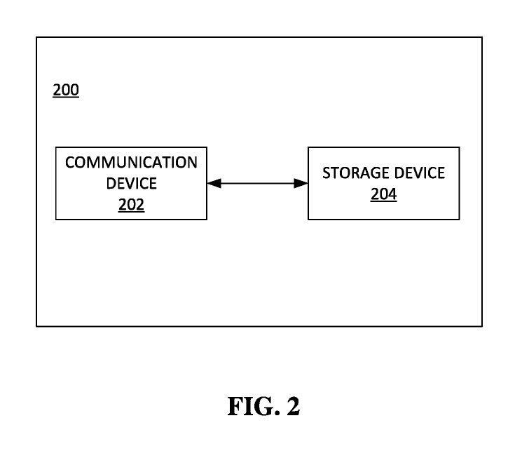

FIG. 2 is a block diagram representation of a system 200 for customizing a card, in accordance with some embodiments. Further, in some embodiments, the card may include at least one of (but not limited to) a bank card, a loyalty card, a social security card, a food card, a business card, an identity card, and so on. Accordingly, the system 200 may include a communication device 202 configured for receiving a customization request for generating a customized card from a user device. For example, the customization request may be received from the user 112 with a user device such as the mobile device 106. Further, in some embodiments, the customized card may include (but not limited to) a physical card, and/or a virtual card.

Further, the communication device 202 may be configured for transmitting an executable content to the user device based on the customization request. For example, the executable content may be an applet, a plugin, a JavaScript code. Further, the executable content, upon execution on a processor included in the user device, may be configured for receiving, using an input device, a selection of at least one digital content. Further, the executable content may be configured for retrieving, using a memory device, at least one digital content based on the selection. Further, in some embodiments, the retrieving of the at least one digital content may be performed from a digital content gallery stored in the memory device. Further, the executable content may be configured for receiving, using the input device, at least one digital content manipulation. For example, the at least one digital content manipulation may include one or more of resizing, cropping, flipping, and applying filters. Further, the executable content may be configured for generating, using the processor, at least one manipulated digital content based on the at least one digital content and the at least one digital content manipulation. Further, the executable content may be configured for transmitting, using a transceiver device, the at least one manipulated digital content.

Further, the communication device 202 may be configured for receiving the at least one manipulated digital content.

Further, the system 200 may include a storage device 204 configured for storing the at least one manipulated digital content.

Further, in some embodiments, the selection may include indication of at least one storage server. Further, in some embodiments, the at least one storage server may correspond to at least one social media account associated with a user. For example, the at least one storage server may correspond to a social media account such as, but not limited to, Facebook™, Instagram™, Google Drive™, Google Photos™, and Dropbox™. Further, the executable content may be configured for transmitting, using the transceiver device, at least one digital content request to the at least one storage server based on the selection. Further, the executable content may be configured for receiving, using the transceiver device, the at least one digital content from the at least one storage server. Further, the executable content may be configured for storing the at least one digital content in the memory device. Further, in some embodiments, the executable content may be configured for receiving, using the input device, at least one user credential. For example, the at least one user credential may include login details for at least one social media account. Further, the executable content may be configured for transmitting, using the transceiver device, the at least one user credential to the at least one storage server. Further, the at least one storage server may perform authentication based on the at least one user credential. Further, the at least one storage server may be configured to transmit the at least one digital content in response to the at least one digital content request based on the authentication.

In some embodiments, the system 200 may further include a processing device configured for generating a unique identifier based on the customization request. For example, the unique identifier may be a text including an alphanumeric string. Further, the communication device 202 may be configured for transmitting the unique identifier to the user device. Further, the communication device 202 may be configured for receiving each of the at least one manipulated digital content and the unique identifier from the user device. Further, the storage device 204 may be configured for storing each of the at least one manipulated digital content, the unique identifier and an association between the at least one manipulated digital content and the unique identifier.

Further, in some embodiments, the communication device 202 may be configured for transmitting the unique identifier to a personalization server. Further, the communication device 202 may be configured for receiving the unique identifier from the personalization server. Further, the communication device 202 may be configured for transmitting the at least one manipulated digital content to the personalization server. Further, the personalized server may be communicatively coupled to a card printer configured for printing the customized card based on the at least one manipulated digital content.

Further, in some embodiments, the processing device may be configured for analyzing the at least one digital content. For example, the analyzing may include image processing. Further, the processing device may be configured for identifying an acceptability of the at least one digital content based on the analyzing. Further, in some embodiments, the identifying of acceptability may be based on a predetermined set of guidelines associated with semantic content of the at least one digital content. For example, the predetermined set of guidelines may relate to restricting use of obscene images or copyrighted images. Further, the communication device 202 may be configured for transmitting the acceptability to the user device.

Further, in some embodiments, the executable content may be configured for monitoring, using the processor, user interactions associated with a user of the user device. Further, the executable content may be configured for determining, using the processor, user preferences associated with the user based on the monitoring. For example, determining user preferences may include use of Artificial Intelligence and Machine Learning tools. Further, the executable content may be configured for identifying, using the processor, the at least one digital content based on the user preferences. Further, the executable content may be configured for recommending, using the processor, the at least one digital content based on the user preferences. Further, the selection of the at least one digital content may be received in response to the recommending.

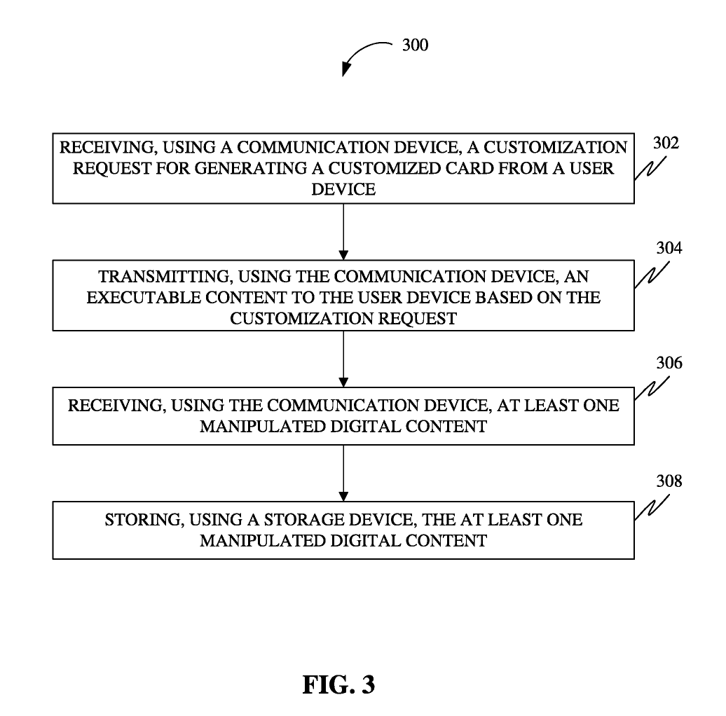

FIG. 3 is a flowchart of a computer implemented method 300 for customizing a card, in accordance with some embodiments. Further, in some embodiment, the card may include at least one of a bank card, a loyalty card, a social security card, a food card, a business card and an identity card. Accordingly, at 302, the computer implemented method 300 may include receiving, using a communication device (such as the communication device 202), a customization request for generating a customized card from a user device. For example, the customization request may be received from the user 112 with a user device such as the mobile device 106. Further, in some embodiments, the customized card may include at least one of a physical card, and a virtual card.

Further, at 304, the computer implemented method 300 may include transmitting, using the communication device, an executable content to the user device based on the customization request. For example, the executable content may be an applet, a plugin, a JavaScript code. Further, the executable content, upon execution on a processor included in the user, may be configured for receiving, using an input device, a selection of at least one digital content. Further, in an instance, the at least one digital content may include at least one of a static content (such as, but not limited to, images, graphs, drawings, and so on), and a dynamic content (such as, but not limited to, gifs, Audio/Video content, and so on). Further, the executable content may be configured for retrieving, using a memory device, the at least one digital content based on the selection. Further, in some embodiments, the retrieving of at least one digital content may be performed from a digital content gallery stored in the memory device. Further, the executable content may be configured for receiving, using the input device, at least one digital content manipulation. For example, the at least one digital content manipulation may include one or more of resizing, cropping, flipping, and applying filters. Further, the executable content may be configured for generating, using the processor, at least one manipulated digital content based on the at least one digital content and the at least one digital content manipulation. Further, the executable content may be configured for transmitting, using a transceiver device, the at least one manipulated digital content.

Further, at 306, the computer implemented method 300 may include receiving, using the communication device, the at least one manipulated digital content.

Further, at 308, the computer implemented method 300 may include storing, using a storage device (such as the storage device 204), the at least one manipulated digital content.

In some embodiments, the selection may include indication of at least one storage server. Further, in some embodiments, the at least one storage server may correspond to at least one social media account associated with a user. For example, the at least one storage server may correspond to a social media account such as, but not limited to, Facebook™, Instagram™, Google Drive™, Google Photos™, and Dropbox™. Further, the executable content may be configured for transmitting, using the transceiver device, at least one digital content request to the at least one storage server based on the selection. Further, the executable content may be configured for receiving, using the transceiver device, the at least one digital content from the at least one storage server. Further, the executable content may be configured for storing the at least one digital content in the memory device. In some embodiments, the executable content may be further configured for receiving, using the input device, at least one user credential. For example, the at least one user credential may include login details for at least one social media account. Further, the executable content may be configured for transmitting, using the transceiver device, the at least one user credential to the at least one storage server. Further, the at least one storage server may perform authentication based on the at least one user credential. Further, the at least one storage server may be configured to transmit the at least one digital content in response to the at least one digital content request based on the authentication.

In some embodiments, the executable content may be further configured for monitoring, using the processor, user interactions associated with a user of the user device. Further, the executable content may be configured for determining, using the processor, user preferences associated with the user based on the monitoring. For example, determining user preferences may include use of Artificial Intelligence and Machine Learning tools. Further, the executable content may be configured for identifying, using the processor, the at least one digital content based on the user preferences. Further, the executable content may be configured for recommending, using the processor, the at least one digital content based on the user preferences. Further, the selection of the at least one digital content may be received in response to the recommending.

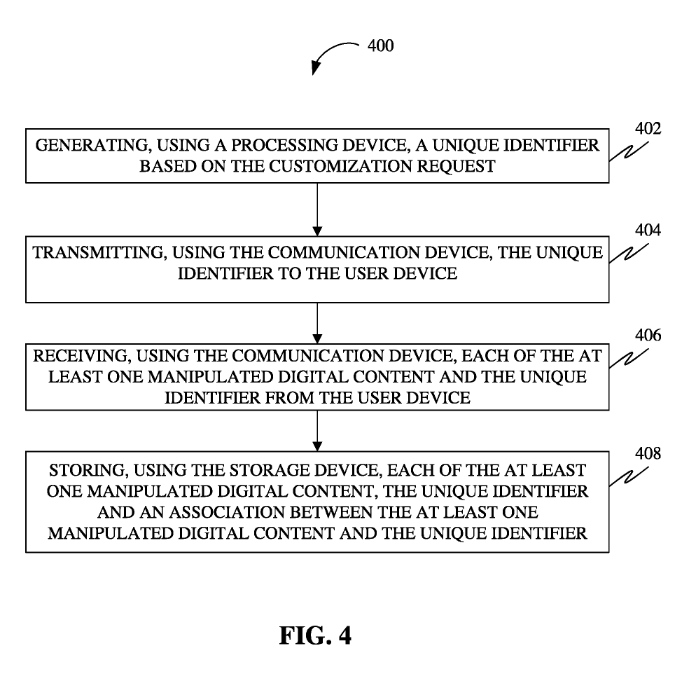

FIG. 4 is a flowchart of a computer implemented method 400 to facilitate obtaining identifier for manipulated digital content, in accordance with some embodiments. Accordingly, at 402, the computer implemented method 400 may include generating, using a processing device, a unique identifier based on the customization request. For example, the unique identifier may be a text including an alphanumeric string. Further, the online platform 100 may include the processing device.

Further, at 404, the computer implemented method 400 may include transmitting, using the communication device, the unique identifier to the user device.

Further, at 406, the computer implemented method 400 may include receiving, using the communication device, each of the at least one manipulated digital content and the unique identifier from the user device.

Further, at 408, the computer implemented method 400 may include storing, using the storage device, each of the at least one manipulated digital content, the unique identifier and an association between the at least one manipulated digital content and the unique identifier.

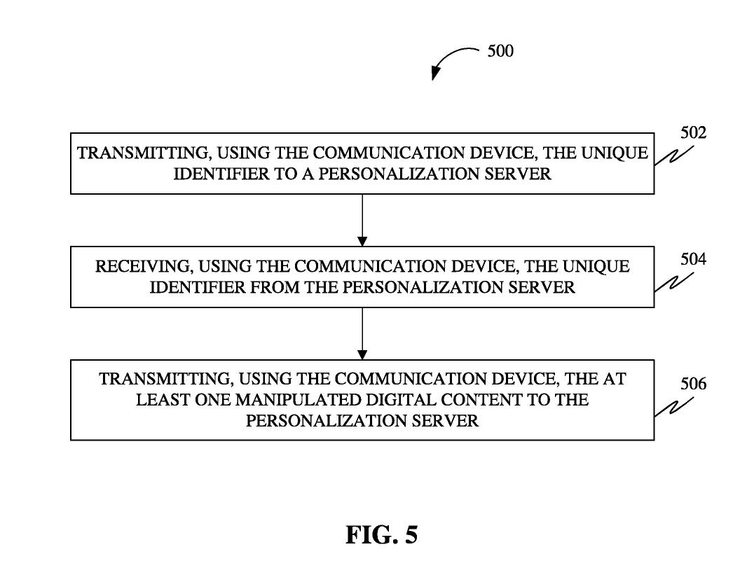

FIG. 5 is a flowchart of a computer implemented method 500 for facilitating customized card printing, in accordance with some embodiments. Accordingly, at 502, the computer implemented method 500 may include transmitting, using the communication device, the unique identifier to a personalization server. For example, the unique identifier may be transmitted to the personalization server when the unique identifier may be transmitted to the user device at 404.

Further, at 504, the computer implemented method 500 may include receiving, using the communication device, the unique identifier from the personalization server.

For example, the unique identifier may be received from the personalization server when the at least one manipulated digital content may be stored in the storage device. Further, the unique identifier may be received from the personalization server upon receiving an approval from the user device.

Further, at 506, the computer implemented method 500 may include transmitting, using the communication device, the at least one manipulated digital content to the personalization server. Further, the personalization server may be communicatively coupled to a card printer configured for printing the customized card based on the at least one manipulated digital content.

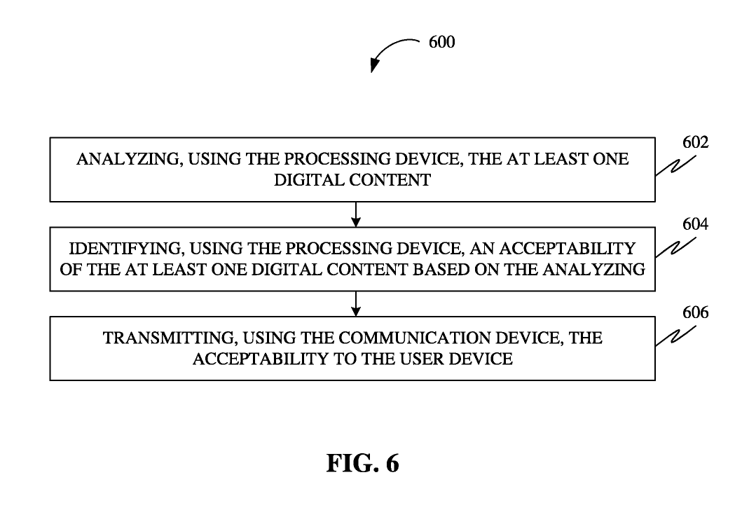

FIG. 6 is a flowchart of a computer implemented method 600 to facilitate determining an accessibility of a digital content, in accordance with some embodiments. Accordingly, at 602, the computer implemented method 600 may include analyzing, using the processing device, the at least one digital content. For example, the analyzing may include image processing.

Further, at 604, the computer implemented method 600 may include identifying, using the processing device, an acceptability of the at least one digital content based on the analyzing. Further, in some embodiments, identifying the acceptability may be based on a predetermined set of guidelines associated with semantic content of the at least one digital content. For example, the predetermined set of guidelines may relate to restricting use of obscene images or copyrighted images.

Further, at 606, the computer implemented method 600 may include transmitting, using the communication device, the acceptability to the user device.

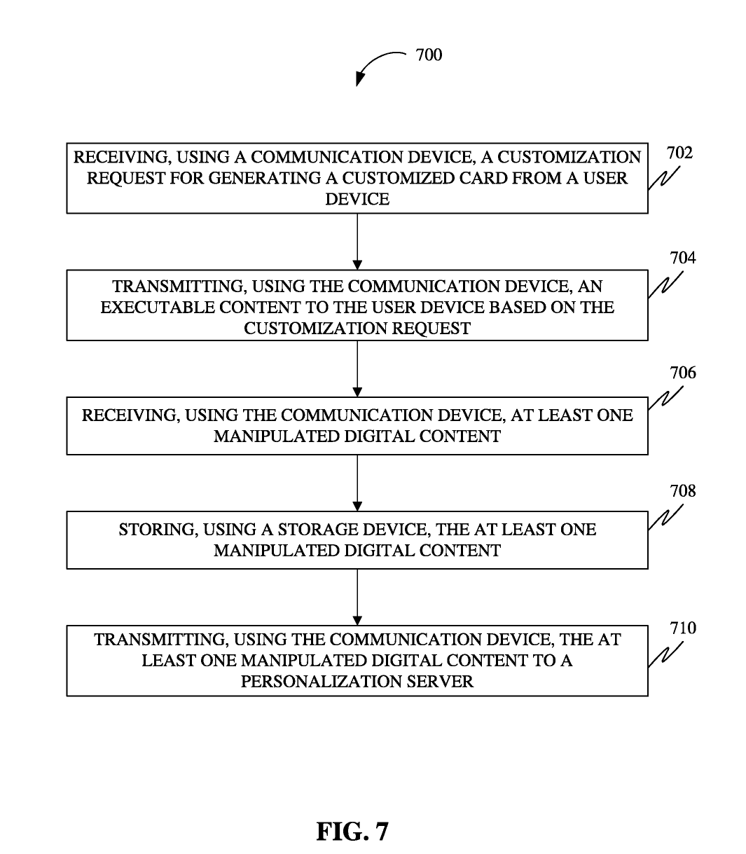

FIG. 7 is a flowchart of a computer implemented method 700 for customizing a card, in accordance with some embodiments. Further, in some embodiment, the card may include at least one of a bank card, a loyalty card, a social security card, a food card, a business card and an identity card. Accordingly, at 702, the computer implemented method 700 may include receiving, using a communication device, a customization request for generating a customized card from a user device. Further, in some embodiments, the customized card may include at least one of a physical card, and a virtual card.

Further, at 704, the computer implemented method 700 may include transmitting, using the communication device, an executable content to the user device based on the customization request. Further, the executable content, upon execution on a processor comprised in the user device, may be configured for receiving, using an input device, a selection of at least one digital content. Further, the executable content may be configured for retrieving, using a memory device, the at least one digital content based on the selection. Further, the executable content may be configured for receiving, using the input device, at least one digital content manipulation. Further, the executable content may be configured for generating, using the processor, at least one manipulated digital content based on the at least one digital content and the at least one digital content manipulation. Further, the executable content may be configured for transmitting, using a transceiver device, the at least one manipulated digital content.

Further, at 706, the computer implemented method 700 may include receiving, using the communication device, the at least one manipulated digital content.

Further, at 708, the computer implemented method 700 may include storing, using a storage device, the at least one manipulated digital content.

Further, at 710, the computer implemented method 700 may include transmitting, using the communication device, the at least one manipulated digital content to a personalization server. Further, the personalization server may be communicatively coupled to a card printer configured for printing the customized card based on the at least one manipulated digital content.

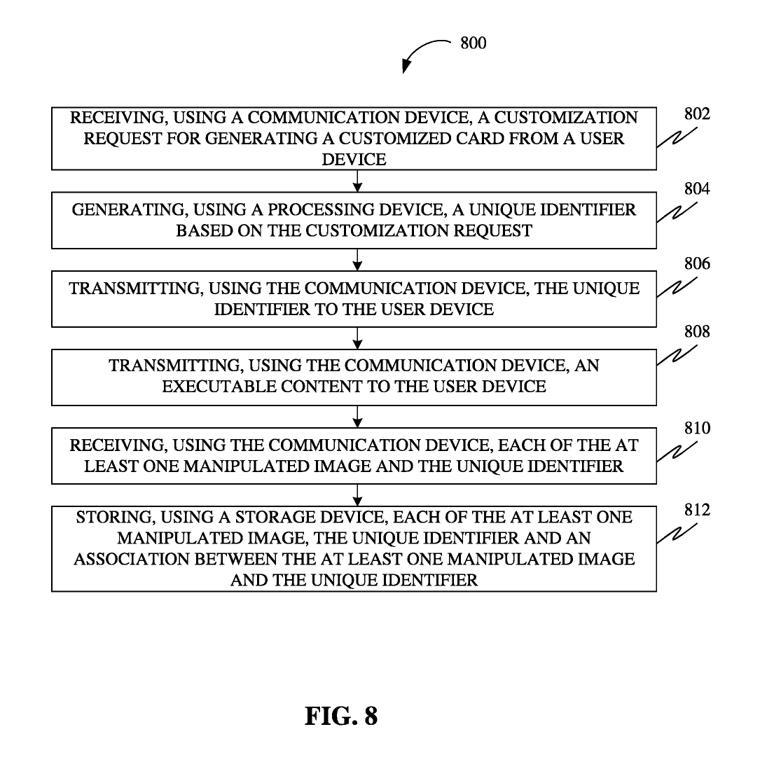

FIG. 8 is a flowchart of a computer implemented method 800 of customizing a card in accordance with some embodiments. The card may include one or more of a bank card, a loyalty card, a social security card, a food card, a business card and an identity card.

At 802, the computer implemented method 800 may include receiving, using a communication device, a customization request for generating a customized card from a user device. For example, the customization request may be received from the user 112 with a user device such as the mobile device 106. Further, the online platform 100 may include the communication device.

Then, at 804, the computer implemented method 800 may include generating, using a processing device, a unique identifier based on the customization request. For example, the unique identifier may be a text including an alphanumeric string. Further, the online platform 100 may include the processing device. Next, at 806, the computer implemented method 800 may include transmitting, using the communication device, the unique identifier to the user device.

Yet further, at 808, the computer implemented method 800 may include transmitting, using the communication device, an executable content to the user device. For example, the executable content may be an applet, a plugin, a JavaScript code. Further, the executable content, upon execution on a processor comprised in the user device, may be configured for receiving, using an input device, a selection of at least one image. In some embodiments, the selection may include indication of at least one storage server, wherein the executable content may be further configured for transmitting, using the transceiver device, at least one image request to the at least one storage server based on the selection. The at least one storage server may correspond to at least one social media account associated with a user. For example, the at least one storage server may correspond to a social media account such as, but not limited to, Facebook™Instagram™, Google Drive™, Google Photos™, and Dropbox™. In further embodiments, the executable content may be configured for receiving, using an input device of the user device, at least one user credential. For example, the at least one user credential may include login details for at least one social media account. Moreover, the executable content may be configured for transmitting, using the transceiver device, the at least one user credential to the at least one storage server. Further, the at least one storage server performs authentication based on the at least one user credential. Further, the at least one storage server may be configured to transmit the at least one image in response to the at least one image request based on the authentication. Yet further, the executable content may be configured for receiving, using the transceiver device, the at least one image from the at least one storage server. Moreover, the executable content may be further configured for storing the at least one image in a memory device in the user device.

Yet further, the executable content may be configured for retrieving, using the memory device in the user device, the at least one image based on the selection. In some embodiments, the retrieving of at least one image may be performed from an image gallery stored in the memory device. For example, the at least one image may be received from the at least one storage server.

Further, the executable content may be configured for receiving, using the input device, at least one image manipulation. For example, the at least one image manipulation may include one or more of resizing, cropping, flipping, and applying filters. Moreover, the executable content may be configured for generating, using the processor, at least one manipulated image based on the at least one image and the at least one image manipulation. Further, the executable content may be configured for transmitting, using a transceiver device, each of the at least one manipulated image and the unique identifier.

Further, at 810, the computer implemented method 800 may include receiving, using the communication device, each of the at least one manipulated image and the unique identifier. Further, at 812, the computer implemented method 800 may include storing, using a storage device, each of the at least one manipulated image, the unique identifier and an association between the at least one manipulated image and the unique identifier. For example, the online platform 100 may include the storage device.

In some embodiments, the executable content may be further configured for monitoring, using the processor (of the user device), user interactions associated with a user of the user device. Further, the executable content may be configured for determining, using the processor, user preferences associated with the user based on the monitoring. For example, determining user preferences may include use of Artificial Intelligence and Machine Learning tools. Yet further, the executable content may be configured for identifying, using the processor, the at least one image based on the user preferences. Moreover, the executable content may be configured for recommending, using the processor, the at least one image based on the user preferences. Further, the selection of the at least one image may be received in response to the recommending.

According to some embodiments, a system for customizing a card is disclosed. The card may include one or more of a bank card, a loyalty card, a social security card, a food card, a business card and an identity card. The system may include a communication device configured for receiving a customization request for generating a customized card from a user device. For example, the customization request may be received from the user 112 with a user device such as the mobile device 106. The online platform 100 may also include the communication device. Further, the communication device may be configured for transmitting a unique identifier to the user device. For example, the unique identifier may be a text including an alphanumeric string. Further, the communication device may be configured for transmitting an executable content to the user device. For example, the executable content may be an applet, a plugin, a JavaScript code. Further, the executable content, upon execution on a processor comprised in the user device, may be configured for receiving, using an input device, a selection of at least one image. In some embodiments, the selection may include indication of at least one storage server, the executable content may be further configured for transmitting, using the transceiver device, at least one image request to the at least one storage server based on the selection. Further, the executable content may be configured for receiving, using the transceiver device, the at least one image from the at least one storage server. Moreover, the executable content may be configured for storing the at least one image in the memory device.

In further embodiments, the executable content may be configured for receiving, using the input device, at least one user credential. For example, the at least one user credential may include login details for at least one social media account. Further, the executable content may be configured for transmitting, using the transceiver device, the at least one user credential to the at least one storage server. For example, the at least one storage server may correspond to at least one social media account associated with a user. For example, the at least one storage server may correspond to a social media account such as, but not limited to, Facebook™, Instagram™, Google Drive™, Google Photos™ and Dropbox™. Further, the at least one storage server performs authentication based on the at least one user credential. Further, the at least one storage server may be configured to transmit the at least one image in response to the at least one image request based on the authentication.

Further, the executable content may be configured for retrieving, using a memory device, the at least one image based on the selection. In some embodiments, the retrieving of at least one image may be performed from an image gallery stored in the memory device.

Further, the executable content may be configured for receiving, using the input device, at least one image manipulation. Further, the executable content may be configured for generating, using the processor, at least one manipulated image based on the at least one image and the at least one image manipulation. Further, the executable content may be configured for transmitting, using a transceiver device, each of the at least one manipulated image and the unique identifier.

Further, the communication device may be configured for receiving each of the at least one manipulated image and the unique identifier.

Further, the system may include a processing device configured for generating the unique identifier based on the customization request. The online platform 100 may also include the processing device.

Further, the system may include a storage device configured for storing each of the at least one manipulated image, the unique identifier and an association between the at least one manipulated image and the unique identifier.

In some embodiments, the communication device may be further configured for transmitting the unique identifier to a personalization server. Yet further, the communication device may be configured for receiving the unique identifier from the personalization server. The communication device may be further configured for transmitting the at least one manipulated image to the personalization server. Further, the personalization server may be communicatively coupled to a card printer configured for printing the customized card based on the at least one manipulated image.

In some embodiments, the processing device may be further configured for analyzing the at least one image. Further, the processing device may be configured for identifying an acceptability of the at least one image based on the analyzing. The communication device may be further configured for transmitting the acceptability to the user device. In further embodiments, identifying the acceptability may be based on a predetermined set of guidelines associated with semantic content of the at least one image. For example, the predetermined set of guidelines may relate to restricting use of obscene images or copyrighted images.

In some embodiments, the executable content may be further configured for monitoring, using the processor, user interactions associated with a user of the user device. Further, the executable content may be configured for determining, using the processor, user preferences associated with the user based on the monitoring. For example, determining user preferences may include use of Artificial Intelligence and Machine Learning tools. Yet further, the executable content may be configured for identifying, using the processor, the at least one image based on the user preferences. Moreover, the executable content may be configured for recommending, using the processor, the at least one image based on the user preferences. Further, the selection of the at least one image may be received in response to the recommending.

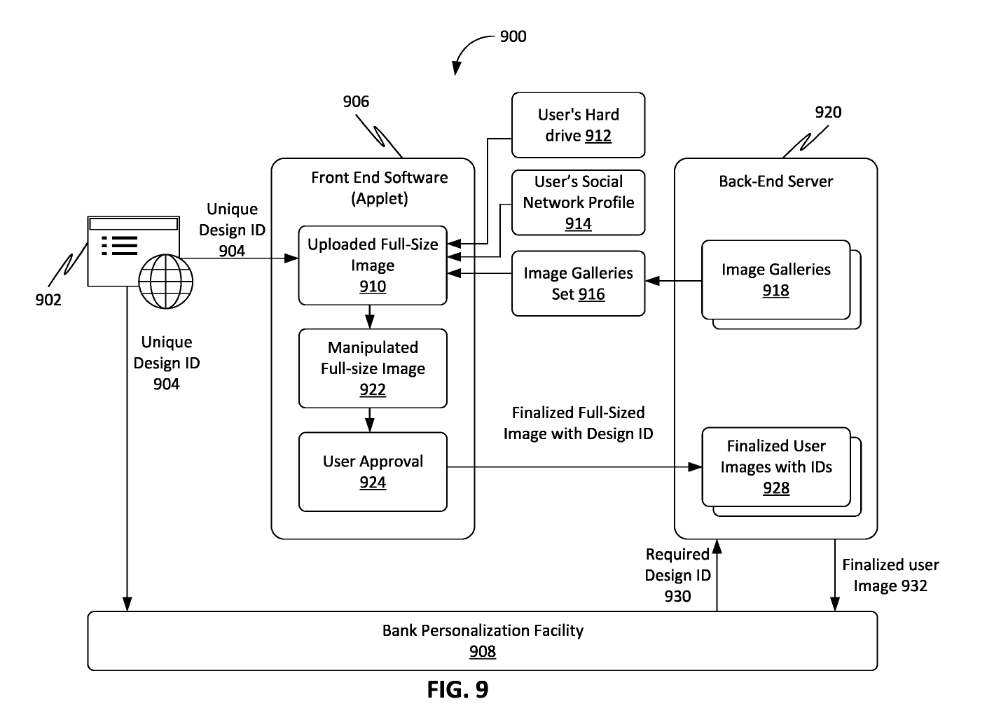

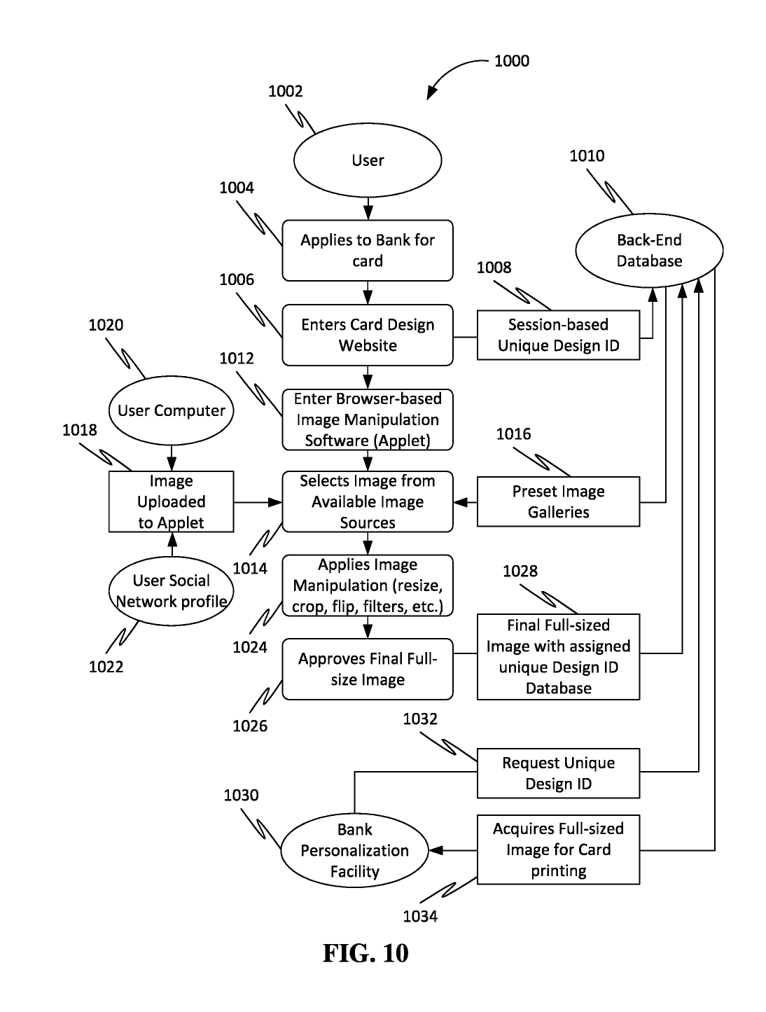

According to some embodiments, an image manipulation system for credit card customization is disclosed. The image manipulation system may include one or more of a client-side based image manipulation process, a set of system architecture flow processes, a set of user flow processes, a process for sending the finalized full-sized image, a process for sourcing images, and a customization support process. The set of system architecture flow processes is explained in further detail in conjunction with FIG. 9 below. The set of user flow processes is explained in further detail in conjunction with FIG. 10 below. The client-side based image manipulation process may perform all image manipulation on the client-side. For example, all image manipulation may be performed on the client side, using a web applet running in the client browser.

FIG. 9 is a block diagram corresponding to the set of system architecture flow processes 900 in accordance with some embodiments. First, a bank website 902 may send a unique design ID 904 to a front end software 906, which may be an applet. For example, the bank website may be hosted on the online platform 100. The bank website 902 may also send the unique design ID 904 to a bank personalization facility 908. For example, the bank personalization facility 908 may include the personalization server 116.

The front end software 906 (an applet) may be configured to obtain an uploaded full-size image 910. The uploaded full-size image 910 may come from the user's hard drive 912, the user's social network profile 914, and the image galleries set 916. The image galleries set 916 may obtain image galleries 918 from a back-end server 920. For example, the back-end server 920 may include the databases 114.

Further, the user may use the front end software 906 to manipulate the uploaded full-size image 910 to obtain a manipulated full-size image 922. Thereafter, the user may use the front end software 906 to approve the manipulated full-size image 922 at 924.

Once the user approves the manipulated full-size image 922, the front end software 906 may send the finalized full-sized image (the manipulated full-size image 922) with unique design ID 904 to a back-end server 920. The back-end server 920 may store multiple finalized user images with unique design IDs 928.

Thereafter, the bank personalization facility 908 may send data pertaining to the required design ID 930 to the back-end server 920. In response, the back-end server 920 may send the finalized user image 932 to the bank personalization facility 908. Finally, the bank personalization facility 908 may print the finalized user image 932 to a card. The bank personalization facility 908 may be located inside a bank, outsourced to bank bureau, or other third party.

FIG. 10 is a flow chart corresponding to the set of user flow processes 1000 in accordance with some embodiments. First, a user 1002 may apply to the bank for a card at 1004. The user may enter a card design website at 1006, wherein a session-based unique design ID 1008 is generated. The session-based unique design ID 1008 may be sent to a back end database 1010. For example, the card design website may be hosted on the online platform 100.

Thereafter, the user may enter a browser-based image manipulation software, (such as an applet) at 1012. Then, the user may select an image from available image sources at 1014.

One of the image sources may be a set of preset image galleries 1016, which may be linked to the back end database 1010. In an embodiment, the back end database 1010 may be a database in the databases 114. Other possible image sources may include images which are uploaded to the browser-based image manipulation software at 1018.

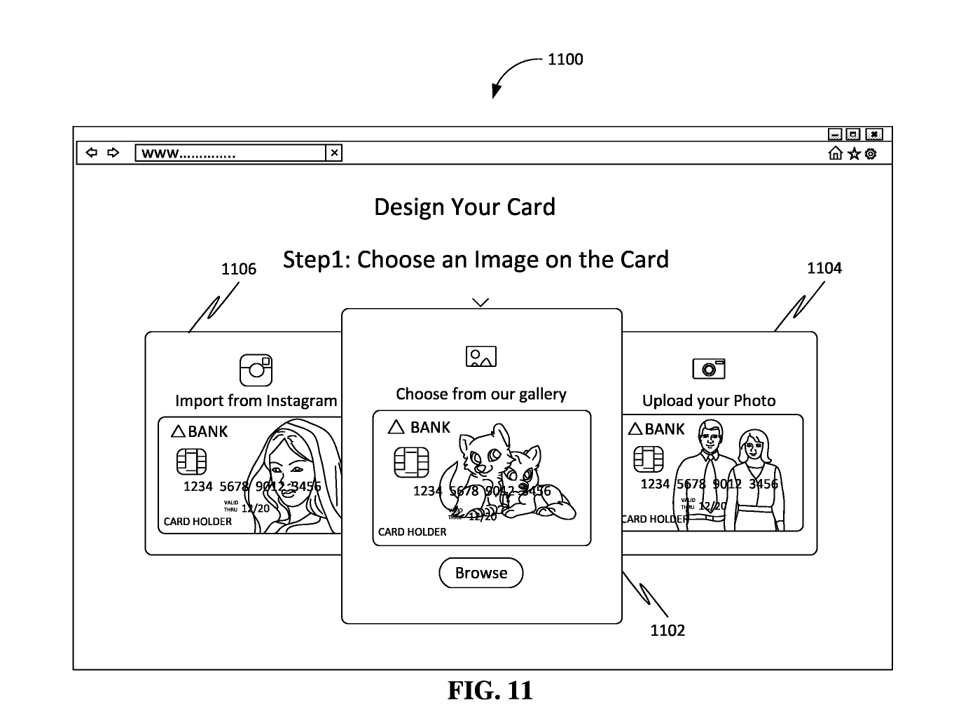

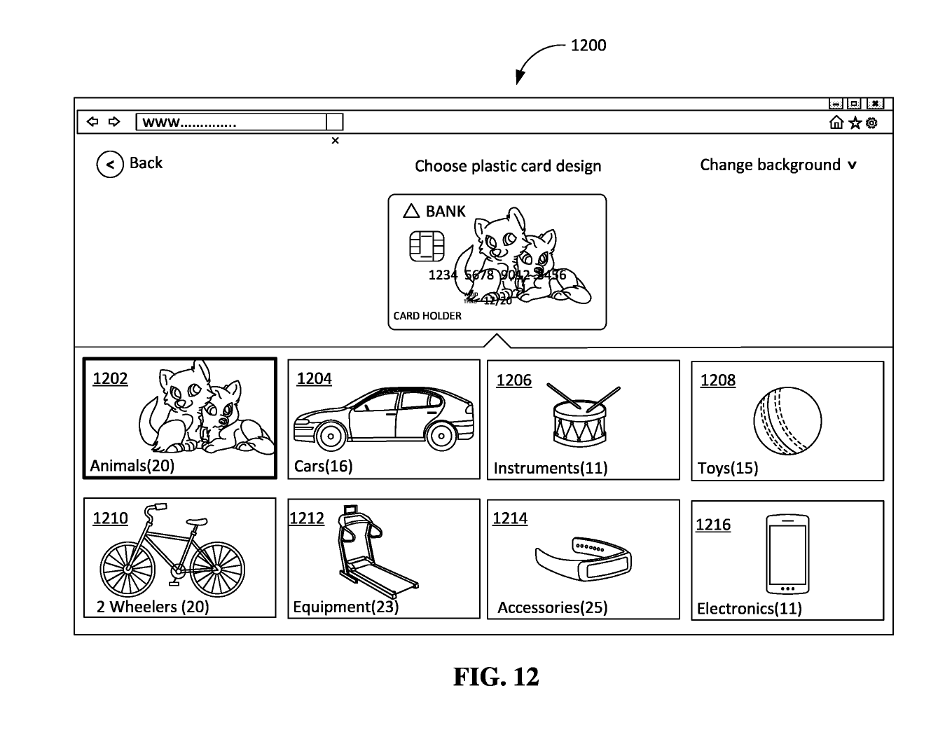

These images may be uploaded from a user computer 1020 or a user social network profile 1022. This is explained in further detail in conjunction with FIG. 11 and FIG. 12 below.

In some embodiments, the process for sourcing images may be configured to provide images. The images may be locally sourced from the user's hard drive. Further, the images may also be sourced from users' social media accounts, such as from Facebook™, Instagram™, etc. Moreover, the images may be obtained from one or more preset images galleries.

FIG. 11 illustrates a user interface 1100 for allowing the user to upload an image, in accordance with an exemplary embodiment. The user interface 1100 shows three options including Choose from our gallery option 1102, Upload your photo option 1104 and Import from Instagram™ option 1106. Further, the user may be allowed to upload an image from one or more social media platforms. The user may select any of the three options to select and upload the image. If the user selects the choose from our gallery option 1102, then a user interface 1200 may be displayed as shown in FIG. 12. The user interface 1200 may show multiple image galleries to the user. For example, the multiple image galleries may include an animal gallery 1202, a cars gallery 1204, an instruments gallery 1206, a toys gallery 1208, a 2 wheelers gallery 1210, an equipment gallery 1212, an accessories gallery 1214, and an electronics gallery 1216.

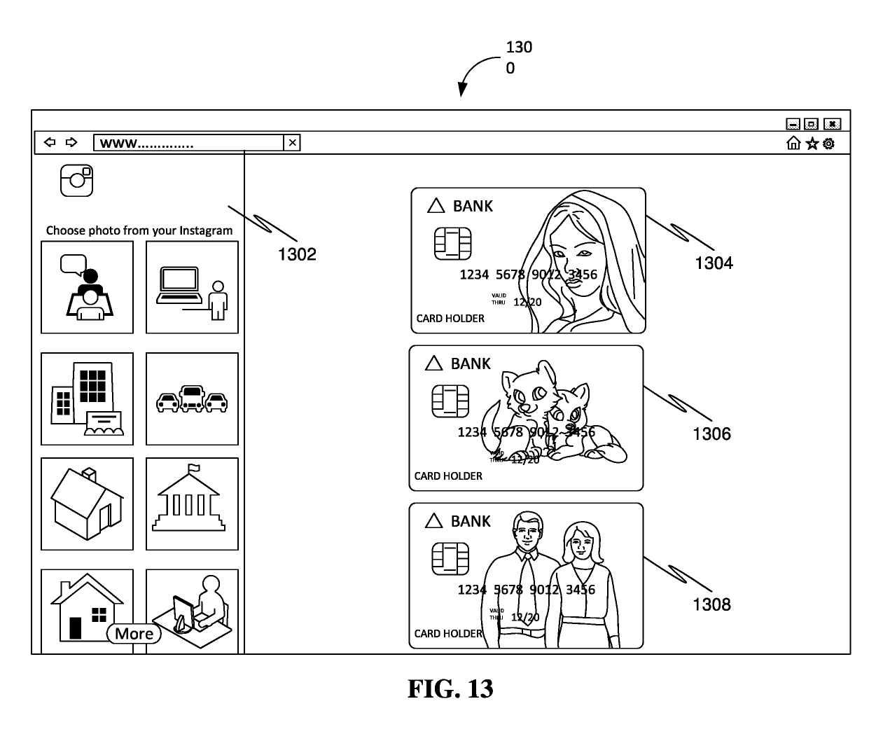

Further, if the user selects the Import from Instagram™ option 1106, then a user interface 1300 may be displayed as shown in FIG. 13. The user interface 1300 may include a pane 1302 which displays multiple images from the user's Instagram™ account. The user may select one or more images. Accordingly, the user interface 1300 may display the selected one or more images on the sample cards (such as sample card 1304, sample card 1306, and sample card 1308).

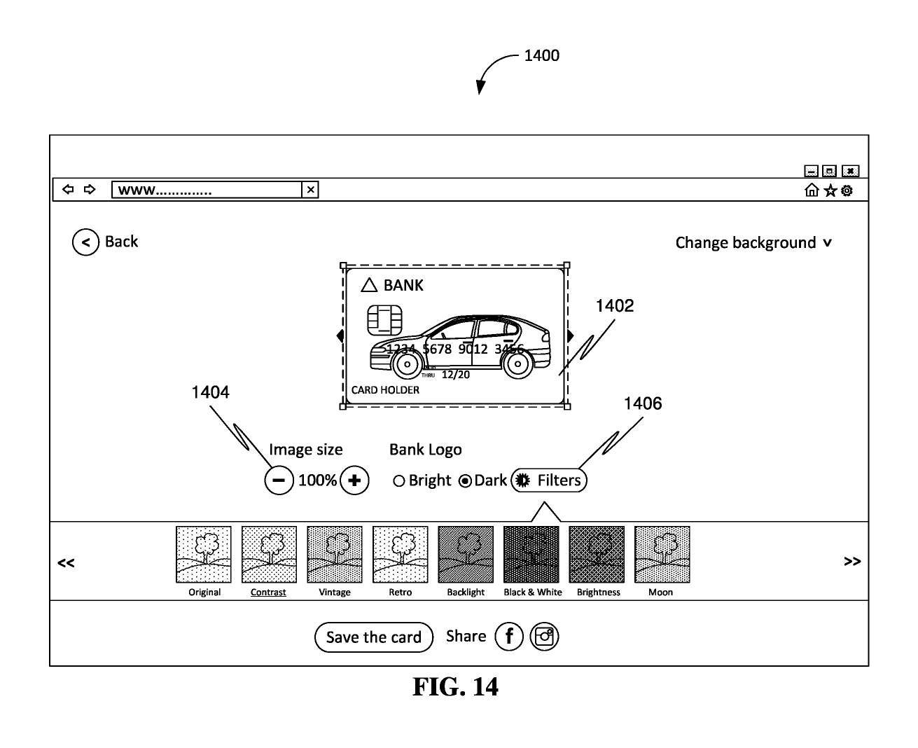

Referring again to FIG. 10, the user may apply image manipulation at 1024. For example, the image manipulation may include actions such as resizing, cropping, flipping, applying filters, etc. FIG. 14 shows a user interface 1400 for allowing the user to apply image manipulation, in accordance with an exemplary embodiment. The user interface 1400 shows a card 1402 with an image selected by the user from an image gallery (such as by using the user interface 1200). Further, the user interface 1400 may provide a user interface element 1404 that allows the user to resize the selected image. Further, the user interface 1400 may provide a user interface element 1406 that allows the user to apply a filter to the selected image. For example, the filters may include one or more of contrast, vintage, retro, backlight, black & white, brightness and moon.

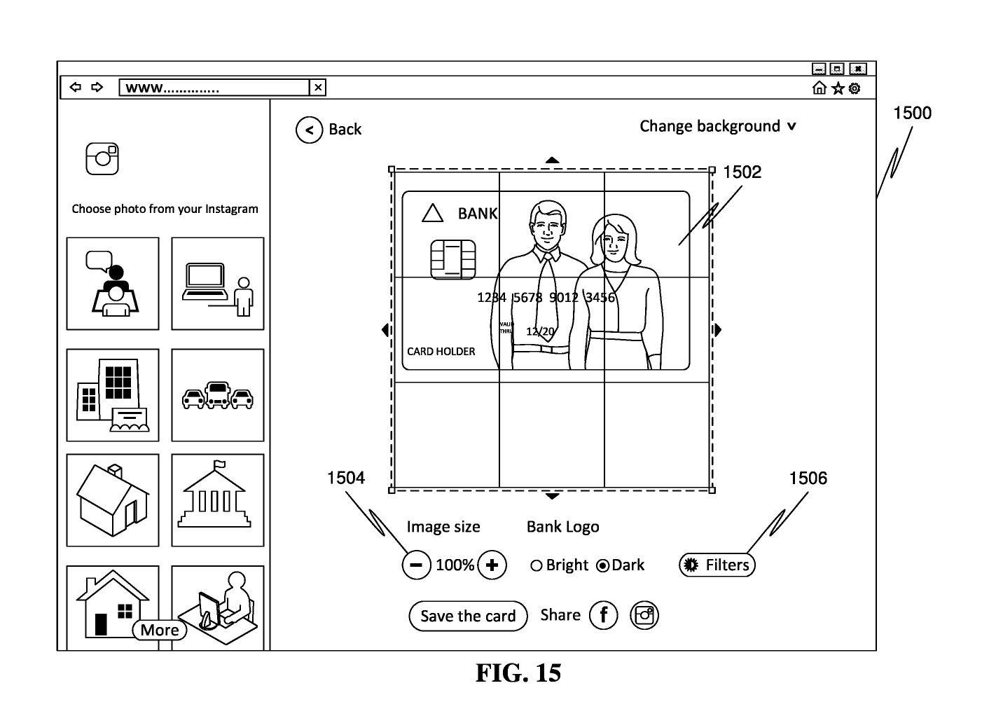

FIG. 15 shows a user interface 1500 for allowing the user to apply image manipulation, in accordance with an exemplary embodiment. The user interface 1500 shows a card 1502 with an image selected by the user from Instagram™ (such as by using the user interface 1300). Further, the user interface 1500 may provide a user interface element 1504 that allows the user to resize the selected image. Further, the user interface 1500 may provide a user interface element 1506 that allows the user to apply a filter to the selected image. In some embodiments, the customization support process may be configured to manipulate the image.

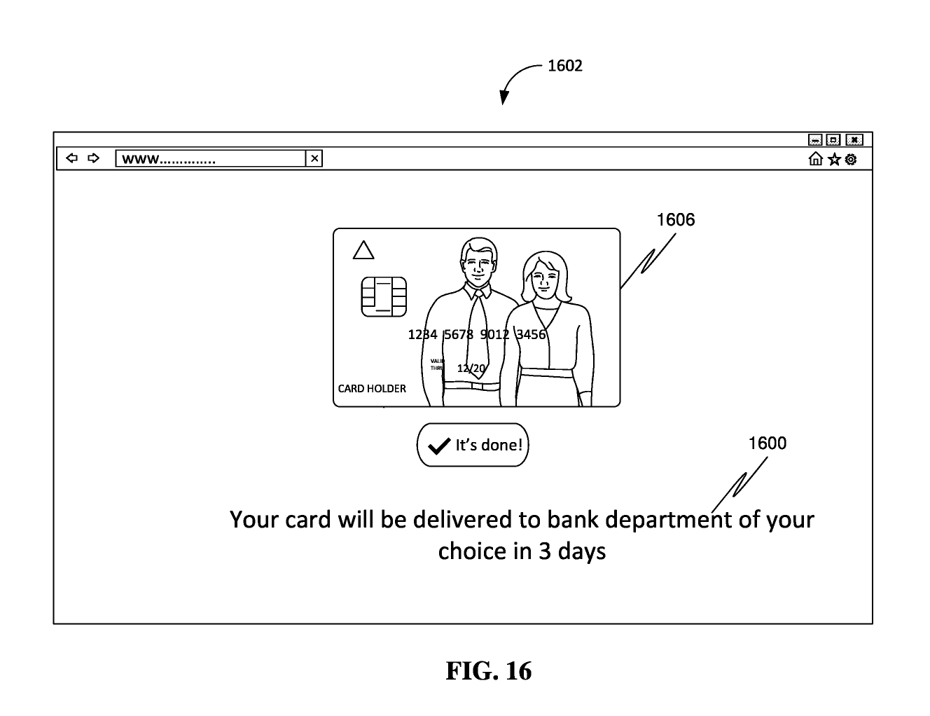

Referring again to FIG. 10, the user may approve the final full-sized image at 1026. Then, the final full-sized image with assigned unique design ID 1028 may be stored in the back end database 1010. Thereafter, the user may be shown a confirmation message 1600 on a user interface 1602 shown in FIG. 16. Further, the user interface 1602 may show the card 1606 with the final image. For example, the confirmation message 1600 may be “Your card will be delivered to bank department of your choice in 3 days”.

Thereafter, a bank personalization facility 1030 may request the full-sized image corresponding to the unique design ID at 1032. In response, the back end database 1010 may send the full-sized image to the bank personalization facility 1030 at 1034. Finally, the bank personalization facility 1030 may print the full-sized image on the card and send the card to the user. In an embodiment, the process for sending the finalized full-sized image may be configured to receive the finalized full-sized image from the back-end server.

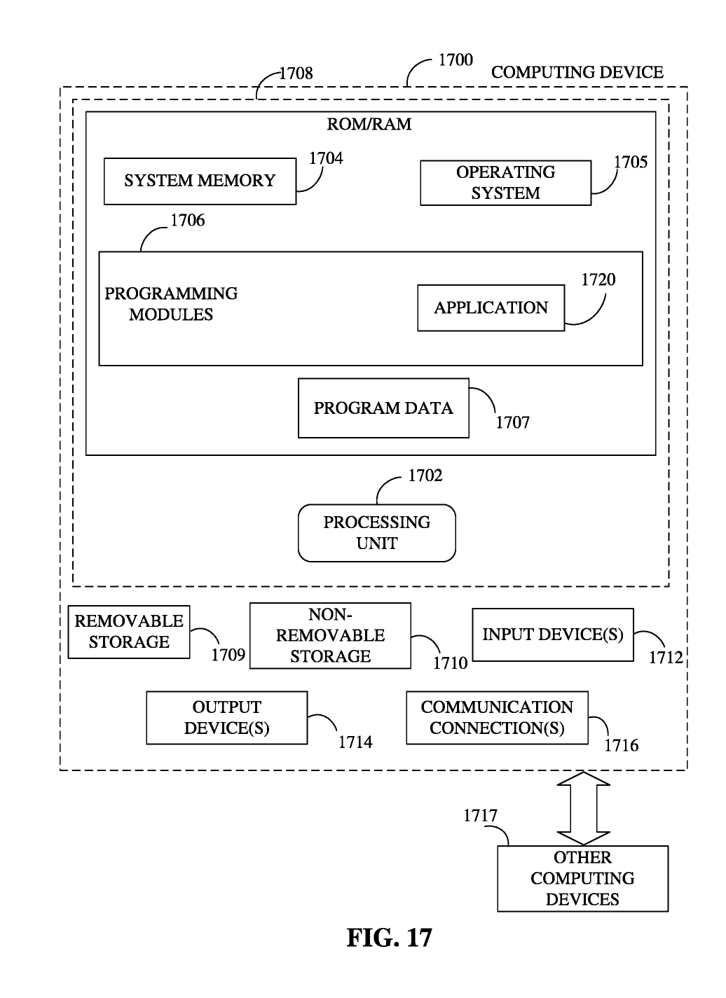

With reference to FIG. 17, a system consistent with an embodiment of the disclosure may include a computing device or cloud service, such as computing device 1700. In a basic configuration, computing device 1700 may include at least one processing unit 1702 and a system memory 1704. Depending on the configuration and type of computing device, system memory 1704 may comprise, but is not limited to, volatile (e.g. random-access memory (RAM)), non-volatile (e.g. read-only memory (ROM)), flash memory, or any combination. System memory 1704 may include operating system 1705, one or more programming modules 1706, and may include a program data 1707. Operating system 1705, for example, may be suitable for controlling computing device 1700's operation. In one embodiment, programming modules 1706 may include image-processing module, machine learning module. Furthermore, embodiments of the disclosure may be practiced in conjunction with a graphics library, other operating systems, or any other application program and is not limited to any particular application or system. This basic configuration is illustrated in FIG. 17 by those components within a dashed line 1708.

Computing device 1700 may have additional features or functionality. For example, computing device 1700 may also include additional data storage devices (removable and/or non-removable) such as, for example, magnetic disks, optical disks, or tape. Such additional storage is illustrated in FIG. 17 by a removable storage 1709 and a non-removable storage 1710. Computer storage media may include volatile and non-volatile, removable and non-removable media implemented in any method or technology for storage of information, such as computer-readable instructions, data structures, program modules, or other data. System memory 1704, removable storage 1709, and non-removable storage 1710 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1700. Any such computer storage media may be part of device 1700. Computing device 1700 may also have input device(s) 1712 such as a keyboard, a mouse, a pen, a sound input device, a touch input device, a location sensor, a camera, a biometric sensor, etc. Output device(s) 1714 such as a display, speakers, a printer, etc. may also be included. The aforementioned devices are examples and others may be used.

Computing device 1700 may also contain a communication connection 1716 that may allow device 1700 to communicate with other computing devices 1718, such as over a network in a distributed computing environment, for example, an intranet or the Internet. Communication connection 1716 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 1704, including operating system 1705. While executing on processing unit 1702, programming modules 1706 (e.g., application 1720 such as a media player) may perform processes including, for example, one or more stages of methods, algorithms, systems, applications, servers, databases as described above. The aforementioned process is an example, and processing unit 1702 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the present disclosure has been explained in relation to its preferred embodiment, it is to be understood that many other possible modifications and variations can be made without departing from the spirit and scope of the disclosure.

What is claimed is:

1. A computer implemented method for customizing a card, the computer implemented method comprising:
receiving, using a communication device, a customization request for generating a customized card from a user device;
transmitting, using the communication device, an executable content to the user device based on the customization request, wherein the executable content, upon execution on a processor comprised in the user device, is configured for:
receiving, using an input device, a selection of at least one digital content;
retrieving, using a memory device, the at least one digital content based on the selection;
receiving, using the input device, at least one digital content manipulation;
generating, using the processor, at least one manipulated digital content based on the at least one digital content and the at least one digital content manipulation; and
transmitting, using a transceiver device, the at least one manipulated digital content;
receiving, using the communication device, the at least one manipulated digital content; and
storing, using a storage device, the at least one manipulated digital content.

2. The computer implemented method of claim 1 further comprising:
generating, using a processing device, a unique identifier based on the customization request;
transmitting, using the communication device, the unique identifier to the user device;
receiving, using the communication device, each of the at least one manipulated digital content and the unique identifier from the user device; and
storing, using the storage device, each of the at least one manipulated digital content, the unique identifier and an association between the at least one manipulated digital content and the unique identifier.

3. The computer implemented method of claim 2, wherein the method further comprising:
transmitting, using the communication device, the unique identifier to a personalization server;
receiving, using the communication device, the unique identifier from the personalization server; and
transmitting, using the communication device, the at least one manipulated digital content to the personalization server, wherein the personalization server is communicatively coupled to a card printer configured for printing the customized card based on the at least one manipulated digital content.

4. The computer implemented method of claim 1, wherein the retrieving of at least one digital content is performed from a digital content gallery stored in the memory device.

5. The computer implemented method of claim 1, wherein the selection comprises indication of at least one storage server, the executable content is further configured for:
transmitting, using the transceiver device, at least one digital content request to the at least one storage server based on the selection;
receiving, using the transceiver device, the at least one digital content from the at least one storage server; and
storing the at least one digital content in the memory device.

6. The computer implemented method of claim 5, wherein the executable content is further configured for:
receiving, using the input device, at least one user credential; and
transmitting, using the transceiver device, the at least one user credential to the at least one storage server, wherein the at least one storage server performs authentication based on the at least one user credential, wherein the at least one storage server is configured to transmit the at least one digital content in response to the at least one digital content request based on the authentication.

7. The computer implemented method of claim 5, wherein the at least one storage server corresponds to at least one social media account associated with a user.

8. The computer implemented method of claim 1, wherein the card comprises at least one of a bank card, a loyalty card, a social security card, a food card, a business card and an identity card.

9. The computer implemented method of claim 2 further comprising:
analyzing, using the processing device, the at least one digital content;
identifying, using the processing device, an acceptability of the at least one digital content based on the analyzing; and
transmitting, using the communication device, the acceptability to the user device.

10. The computer implemented method of claim 9, wherein identifying the acceptability is based on a predetermined set of guidelines associated with semantic content of the at least one digital content.

11. The computer implemented method of claim 1, wherein the executable content is further configured for:
monitoring, using the processor, user interactions associated with a user of the user device;
determining, using the processor, user preferences associated with the user based on the monitoring;
identifying, using the processor, the at least one digital content based on the user preferences; and
recommending, using the processor, the at least one digital content based on the user preferences, wherein the selection of the at least one digital content is received in response to the recommending.

12. A computer implemented method for customizing a card, the computer implemented method comprising:
receiving, using a communication device, a customization request for generating a customized card from a user device;
transmitting, using the communication device, an executable content to the user device based on the customization request, wherein the executable content, upon execution on a processor comprised in the user device, is configured for:
receiving, using an input device, a selection of at least one digital content;
retrieving, using a memory device, the at least one digital content based on the selection;
receiving, using the input device, at least one digital content manipulation;
generating, using the processor, at least one manipulated digital content based on the at least one digital content and the at least one digital content manipulation; and
transmitting, using a transceiver device, the at least one manipulated digital content;
receiving, using the communication device, the at least one manipulated digital content;
storing, using a storage device, the at least one manipulated digital content; and
transmitting, using the communication device, the at least one manipulated digital content to a personalization server, wherein the personalization server is communicatively coupled to a card printer configured for printing the customized card based on the at least one manipulated digital content.

13. A system for customizing a card, the system comprising:
a communication device configured for:
receiving a customization request for generating a customized card from a user device;
transmitting an executable content to the user device based on the customization request, wherein the executable content, upon execution on a processor comprised in the user device, is configured for:
receiving, using an input device, a selection of at least one digital content;
retrieving, using a memory device, the at least one digital content based on the selection;
receiving, using the input device, at least one digital content manipulation;
generating, using the processor, at least one manipulated digital content based on the at least one digital content and the at least one digital content manipulation; and
transmitting, using a transceiver device, the at least one manipulated digital content; and
receiving the at least one manipulated digital content; and
a storage device configured for storing the at least one manipulated digital content.

14. The system of claim 13 further comprising a processing device configured for generating a unique identifier based on the customization request;
wherein the communication device is further configured for:
transmitting the unique identifier to the user device; and
receiving each of the at least one manipulated digital content and the unique identifier from the user device; and
the storage device is further configured for storing each of the at least one manipulated digital content, the unique identifier and an association between the at least one manipulated digital content and the unique identifier.

15. The system of claim 14, wherein the communication device is further configured for:
transmitting the unique identifier to a personalization server;
receiving the unique identifier from the personalization server; and
transmitting the at least one manipulated digital content to the personalization server, wherein the personalization server is communicatively coupled to a card printer configured for printing the customized card based on the at least one manipulated digital content.

16. The system of claim 13, wherein the selection comprises indication of at least one storage server, the executable content is further configured for:
transmitting, using the transceiver device, at least one digital content request to the at least one storage server based on the selection;
receiving, using the transceiver device, the at least one digital content from the at least one storage server; and
storing the at least one digital content in the memory device.

17. The system of claim 16, wherein the executable content is further configured for:
receiving, using the input device, at least one user credential; and
transmitting, using the transceiver device, the at least one user credential to the at least one storage server, wherein the at least one storage server performs authentication based on the at least one user credential, wherein the at least one storage server is configured to transmit the at least one digital content in response to the at least one digital content request based on the authentication.

18. The system of claim 14, wherein the processing device is further configured for:
analyzing the at least one digital content; and
identifying an acceptability of the at least one digital content based on the analyzing; and
the communication device is configured for transmitting the acceptability to the user device.

19. The computer implemented method of claim 18, wherein identifying the acceptability is based on a predetermined set of guidelines associated with semantic content of the at least one digital content.

20. The system of claim 13, wherein the executable content is further configured for:
monitoring, using the processor, user interactions associated with a user of the user device;
determining, using the processor, user preferences associated with the user based on the monitoring;
identifying, using the processor, the at least one digital content based on the user preferences; and
recommending, using the processor, the at least one digital content based on the user preferences, wherein the selection of the at least one digital content is received in response to the recommending.
